(19) United States
(12) Patent Application Publication
(10) Pub. No.: US 2026/0111511 A1
(43) Pub. Date: Apr. 23, 2026

(54) DEPTH-WISE CONVOLUTION WITH INPUT AND OUTPUT PARALLELISM

(71) Applicant: EDGECORTIX INC., Tokyo (JP)

(72) Inventors: Oleg KHAVIN, Tokyo (JP); Anudeep CHERLAPALLY, Tokyo (JP); Kunihiko IETOMI, Tokyo (JP); Nikolay NEZ, Tokyo (JP); Sakyasingha DASGUPTA, Tokyo (JP)

(21) Appl. No.: 18/918,061

(22) Filed: Oct. 17, 2024

(51) Int. Cl. G06F 17/15; G06F 7/544

(52) U.S. Cl. CPC G06F 17/15; G06F 7/5443

(57) ABSTRACT

Depth-wise convolution with input and output parallelism is performed by a plurality of multiply-and-accumulate (MAC) units, each MAC unit including a weight register configured to store a weight value, an activation register configured to store an activation value, a multiplexer configured to transmit the activation value received from one of the activation register and an input line, a multiplier configured to multiply the weight value from the weight register and an activation value from the multiplexer, a memory in communication with the plurality of MAC units, and a controller configured to transmit, from the memory, the weight value of each MAC unit among the plurality of MAC units to the weight register of the MAC unit, and transmit, from the memory, the activation value to an upstream MAC unit among the plurality of MAC units.

### BACKGROUND

Neural network inference chips perform convolution operations, which involves multiply-and-accumulate (MAC) operations. A systolic array can be used to perform pointwise convolution operations with input and output channel parallelism. Depthwise convolution operations are performed by separate chip hardware.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a system for depth-wise convolution with input and output parallelism, according to at least some embodiments of the subject disclosure.

FIG. 2 is a schematic diagram of a systolic array, according to at least some embodiments of the subject disclosure.

FIG. 3 is a schematic diagram of a MAC unit, according to at least some embodiments of the subject disclosure.

FIG. 4 is a schematic diagram of a depthwise convolution process, according to at least some embodiments of the subject disclosure.

FIG. 5A is a schematic diagram of a systolic array at time period T₁, according to at least some embodiments of the subject disclosure.

FIG. 5B is a schematic diagram of a systolic array at time period T₂, according to at least some embodiments of the subject disclosure.

FIG. 5C is a schematic diagram of a systolic array at time period T₃, according to at least some embodiments of the subject disclosure.

FIG. 6 is an operational flow for an operational flow for performing convolution using a systolic array, according to at least some embodiments of the subject disclosure.

FIG. 7 is an operational flow for an operational flow for depth-wise convolution with input and output parallelism, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

Systolic arrays known to the inventors that are used to perform pointwise convolution operations with input and output channel parallelism cannot be used to perform depthwise convolution operations for multiple channels with input and output channel parallelism.

In at least some embodiments described herein, a systolic array used to perform pointwise convolution operations with input and output channel parallelism is modified to add activation registers in serial to each column and multiplexers, one per register, to direct input from the activation registers to the multipliers within the MAC elements instead of the input lines. In at least some embodiments, an upstream activation register of each column is connected to the input line of a single row, from which it receives the activation value. In at least some embodiments, during performance of depth-wise convolution, the upstream activation register passes the received activation value down to the next activation register in the column in addition to performing the MAC operation, and receives the next activation value. In at least some embodiments, downstream activation registers perform the same passing process down to the last activation register. In at least some embodiments, the column repeats the receiving and passing processes until all MAC operations have been performed. In this manner, each channel can be applied to a single column, allowing multiple channels to be processed in parallel, because the systolic array has multiple columns, at least in some embodiments.

In at least some embodiments, depthwise convolution is enabled to be performed using a small amount of additional hardware to the systolic array instead of separate, dedicated chip hardware. In at least some embodiments of such a systolic array result in the performance being the same or better than separate, dedicated chip hardware.

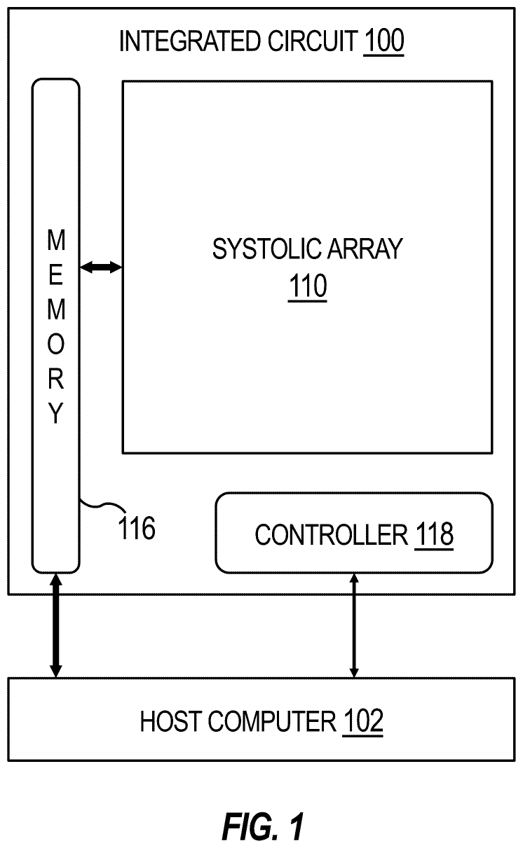

FIG. 1 is a system for depth-wise convolution with input and output parallelism, according to at least some embodiments of the subject disclosure. The system includes integrated circuit 100 and host computer 102.

Integrated circuit 100 is in communication with the host computer 102 and includes systolic array 110, memory 116, and controller 118. In at least some embodiments, integrated circuit 100 is configured to house components for performing depth-wise convolution operations with input and output parallelism. In at least some embodiments, integrated circuit 100 is configured for parallel processing of multiple channels using a systolic array architecture, such as systolic array 110. In at least some embodiments, integrated circuit 100 is configured to communicate with host computer 102 for receiving instructions and data. In at least some embodiments, integrated circuit 100 is configured for convolutional neural network inference. In at least some embodiments, integrated circuit 100 is configured for other types of neural network inference operations. In at least some embodiments, integrated circuit 100 is a silicon chip, a Field-Programmable Gate Array (FPGA), Application Specific Integrated Circuit (ASIC), part of a larger system-on-chip (SoC), etc. In at least some embodiments, integrated circuit 100 is configured for other computational tasks.

Host computer 102 is in communication with integrated circuit 100 for depth-wise convolution tasks. In at least some embodiments, host computer 102 is configured to provide integrated circuit 100 with instructions and data for depth-wise convolution tasks. In at least some embodiments, host computer 102 transmits data and instructions to integrated circuit 100 through a wired connection, a wireless connection, a network, or any other form of electronic communication. In at least some embodiments, host computer 102 receives processed data and results from integrated circuit 100. In at least some embodiments, host computer 102 performs general computing tasks, user interface management, data storage, etc. In at least some embodiments, host computer 102 interfaces with peripherals, storage devices, and network components. In at least some embodiments, host computer 102 is a desktop computer, server, or embedded system. In at least some embodiments, host computer 102 is used for running applications, managing databases, and performing general computing tasks.

Systolic array 110 is in communication with controller 118 and memory 116. In at least some embodiments, systolic array 110 is configured to perform parallel processing of convolution operations using a plurality of MAC units arranged in a grid. In at least some embodiments, systolic array 110 is configured for depth-wise convolution with input and output parallelism by passing activation values through columns of MAC units. In at least some embodiments, systolic array 110 is configured to receive data from memory 116 and control signals from controller 118. In at least some embodiments, systolic array 110 is configured to transmit data to memory 116 for storing resultant values. In at least some embodiments, systolic array 110 is configured for other types of matrix operations with input and output parallelism, such as pointwise convolution.

Memory 116 is in communication with systolic array 110 and host computer 102. In at least some embodiments, memory 116 is configured to store weight values, activation values, and resultant values of convolution operations. In at least some embodiments, memory 116 is an on-chip memory directly connected to systolic array 110. In at least some embodiments, memory 116 communicates with controller 118 to receive and store data. In at least some embodiments, memory 116 is configured for general data storage and retrieval purposes. In at least some embodiments, memory 116 interfaces with external memory or storage devices of host computer 102 for larger datasets. In at least some embodiments, integrated circuit 100 includes a memory 116 in communication with a plurality of MAC units.

Controller 118 is in communication with systolic array 110, memory 116, and host computer 102. In at least some embodiments, controller 118 is configured to manage the operation of systolic array 110 and coordinate data flow. In at least some embodiments, controller 118 is configured to control the transmission of weight values and activation values to the MAC units of systolic array 110. In at least some embodiments, controller 118 is configured to receive instructions from host computer 102. In at least some embodiments, controller 118 is configured to send control signals to systolic array 110 and memory 116. In at least some embodiments, controller 118 interfaces with other controllers or processing units for other operations. In at least some embodiments, controller 118 is a microcontroller or part of a larger control unit. In at least some embodiments, controller 118 is of the type used for managing operations in embedded systems, robotics, and other automated systems. In at least some embodiments, integrated circuit 100 includes a controller 118 configured to transmit, from memory 116, the weight value of each MAC unit among the plurality of MAC units to a weight register of the MAC unit, transmit, from the memory, the activation value to an upstream MAC unit among the plurality of MAC units, and store, on memory 116, the output sum value produced by a last MAC unit among the plurality of MAC units. In at least some embodiments, controller 118 is further configured to perform one of point-wise convolution and depth-wise convolution.

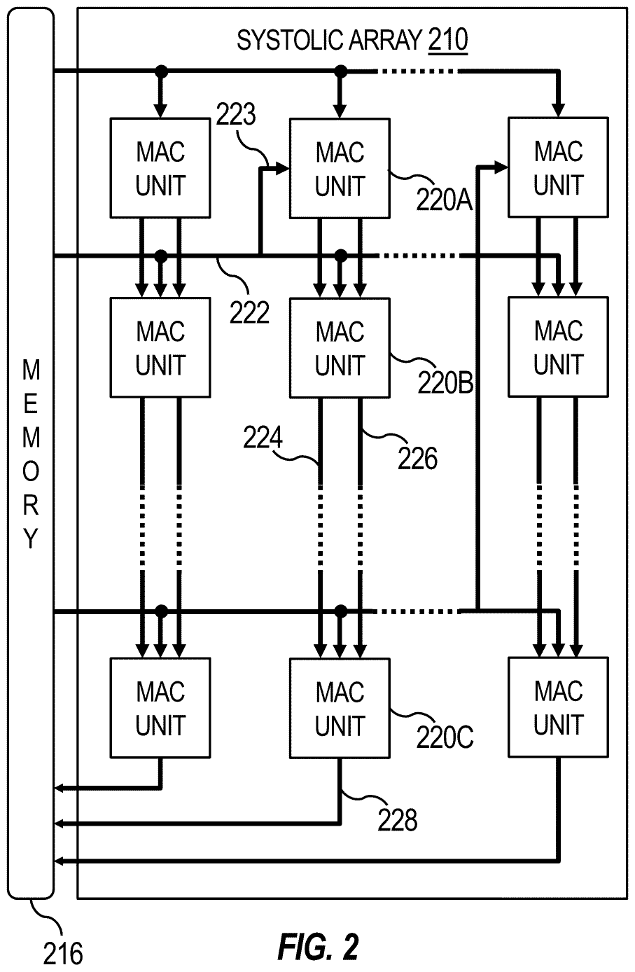

FIG. 2 is a schematic diagram of a systolic array 210, according to at least some embodiments of the subject disclosure. Systolic array 210 is in communication with memory 216 and includes a plurality of MAC units, such as MAC units 220A, 220B, and 220C, activation input line 222, activation input line connector 223, register input line 224, intermediate result input line 226, and output line 228. Memory 216 is substantially similar to memory 116 of FIG. 1 in structure and function, except where otherwise described.

Memory 216 is in communication with the plurality of MAC units via input lines, such as activation input line 222. In at least some embodiments, memory 216 is configured to transmit weight values and activation values via the input lines to the plurality of MAC units. In at least some embodiments, memory 216 is configured to receive and store intermediate and final results of computations via output lines, such as output line 228.

The plurality of MAC units, such as MAC units 220A, 220B, and 220C, are in communication with memory 216. In at least some embodiments, the plurality of MAC units, such as MAC units 220A, 220B, and 220C, are configured to perform MAC operations for convolutional computations. In at least some embodiments, each MAC unit is configured to store weight and activation values in dedicated registers. In at least some embodiments, the plurality of MAC units are configured to receive weight values from memory 216. In at least some embodiments, each MAC unit is configured to receive activation values from either memory 216 or an upstream MAC unit. In at least some embodiments, each MAC unit is configured to pass intermediate results to a downstream MAC unit or back to memory 216. In at least some embodiments, each MAC unit is configured to perform basic arithmetic operations like multiplication and addition. In at least some embodiments, the plurality of MAC units are part of other processing units or arithmetic logic units (ALUs). In at least some embodiments, the plurality of MAC units are arranged in a column of a systolic array. For example, MAC units 220A, 220B, and 220C are arranged in one column. In at least some embodiments, the systolic array includes a plurality of columns forming a matrix of MAC units. In at least some embodiments, each MAC unit is configured to store a weight value and an activation value, transmit the activation value received from one of an activation register storing the activation value and an input line, multiply the weight value and the transmitted activation value to produce a product value, and add the product value and an input sum value to produce an output sum value.

Activation input lines, such as activation input line 222, connect memory 216 to the plurality of MAC units. In at least some embodiments, the activation input line of each MAC unit among the plurality of MAC units is shared among corresponding MAC units of each column. In at least some embodiments, corresponding MAC units of each column that share an activation input line are referred to as a row of MAC units. For example, activation input line 222 is configured for transmission of activation values to MAC unit 220B and the other MAC units among the plurality of MAC units connected to input line 222. In at least some embodiments, the activation input lines are configured for general data transmission. In at least some embodiments, the activation input lines are part of a larger data transmission network. In at least some embodiments, the activation input lines include electrical wiring or traces suitable for integrated circuitry.

Activation input line connectors, such as activation input line connector 223, connect activation input lines to upstream MAC units. In at least some embodiments, each activation input line connector is configured to route data transmitted through an activation input line to a MAC unit at the top of a column of MAC units. In at least some embodiments, activation input line connectors enable use of all MAC units in the performance of depthwise convolution with input and output parallelism. In at least some embodiments, the connection between activation input line connectors and activation input lines is fixed.

Register input lines, such as register input line 224, connect upstream MAC units to downstream MAC units. In at least some embodiments, each register input line is configured for transmission of activation values from an upstream MAC unit to an immediately downstream MAC unit. In at least some embodiments, each register input line is configured to connect registers of sequential MAC units.

Intermediate result input lines, such as intermediate result input line 226, connect upstream MAC units to downstream MAC units. In at least some embodiments, each intermediate result input line is configured for transmission of intermediate results from an upstream MAC unit to an immediately downstream MAC unit. In at least some embodiments, each intermediate result input line is configured to connect adders of sequential MAC units.

Output lines, such as output line 228, connect MAC units to memory 216. In at least some embodiments, each output line is configured for transmission of output sum values from last (most downstream) MAC units of each column in systolic array 210 to memory 216. In at least some embodiments, each output line is configured to connect adders of the last MAC units to memory 216.

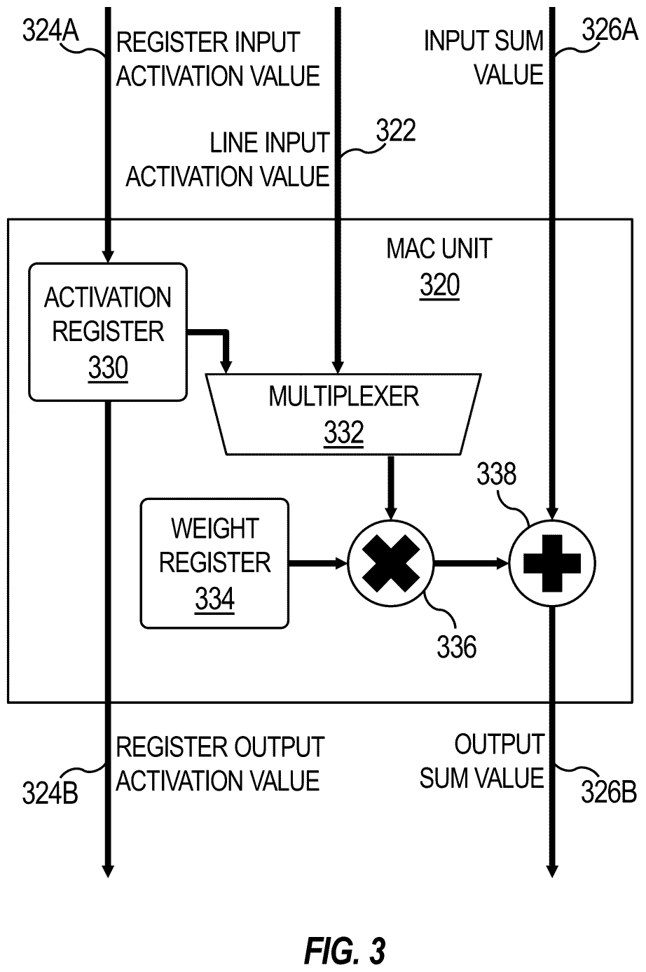

FIG. 3 is a schematic diagram of a MAC unit 320, according to at least some embodiments of the subject disclosure. MAC unit 230 includes activation register 330, multiplexer 332, weight register 334, multiplier 336, and adder 338. In at least some embodiments, each MAC unit includes a weight register configured to store a weight value, an activation register configured to store an activation value, a multiplexer configured to transmit the activation value received from one of the activation register and an input line, a multiplier configured to multiply the weight value from the weight register and the activation value transmitted from the multiplexer to produce a product value, and an adder configured to add the product value from the multiplier and an input sum value to produce an output sum value.

Activation register 330 is in communication with multiplier 336 via multiplexer 332. In at least some embodiments, activation register 330 is configured to store activation values for use in depthwise convolution with input and output parallelism. In at least some embodiments, activation register 330 is configured to transmit activation values to multiplier 336 via multiplexer 332. In at least some embodiments, activation register 330 is configured to receive register input activation values, such as register input activation value 324A, from an activation register of an immediately upstream MAC unit. In at least some embodiments, activation register 330 is configured to transmit register output activation values, such as register output activation value 324B, to an activation register of an immediately downstream MAC unit. In at least some embodiments, activation register 330 is typically implemented in flip-flops or latches in integrated circuitry. In at least some embodiments, activation register 330 is of the type used in various integrated circuits for temporary data storage, such as in registers within CPUs. In at least some embodiments, such as where MAC unit 320 is the upstream MAC unit of at least one column, activation register 330 is configured to receive the activation value through the input line of a downstream MAC unit of the at least one column. In at least some embodiments, such as where MAC unit 320 is the upstream MAC unit of at least one column, activation register 330 is configured to receive the activation value through the input line of the upstream MAC unit.

Multiplexer 332 is configured to selectively connect activation register 330 and multiplier 336. In at least some embodiments, multiplexer 332 is configured to transmit, to multiplier 336, activation values from either activation register 330 for use in depthwise convolution with input and output parallelism or an input line for use in other computations, such as pointwise convolution. In at least some embodiments, multiplexer 332 is configured to select between activation register 330 and the input line based on a signal from a controller, such as controller 118 of FIG. 1. In at least some embodiments, multiplexer 332 is configured to form a direct connection to multiplier 336 from either activation register 330 or the input line. In at least some embodiments, multiplexer 332 is a digital multiplexer circuit, such as those used to select between multiple input signals, commonly found in FPGA or ASIC designs. In at least some embodiments, multiplexer 332 is of the type generally used in data routing, signal selection, and control systems.

Weight register 334 is connected to multiplier 334. In at least some embodiments, weight register 334 is configured to store a weight value for use in depthwise convolution with input and output parallelism and other computations. In at least some embodiments, weight register 334 is configured to transmit the weight value to multiplier 336. In at least some embodiments, weight register 334 is configured to transmit the same weight value to multiplier 336 for multiple sequential computations. In at least some embodiments, weight register 334 is configured to receive weight values from on-chip memory, such as memory 216 of FIG. 2. In at least some embodiments, weight register 334 is typically implemented in flip-flops or latches in integrated circuitry. In at least some embodiments, weight register 334 is of the type used in various integrated circuits for temporary data storage, such as in registers within CPUs.

Multiplier 336 is in communication with activation register 330 and the input line via multiplexer 332, and also in communication with adder 338. In at least some embodiments, multiplier 336 is configured to multiply an activation value with a weight value to produce a product value. In at least some embodiments, multiplier 336 is configured to receive an activation value from multiplexer 332 and a weight value from weight register 334, and to transmit the product value to adder 338. In at least some embodiments, multiplier 336 is configured to perform multiplication of two data values. In at least some embodiments, multiplier 336 is implemented as a digital multiplier circuit, commonly found in FPGA or ASIC designs. In at least some embodiments, multiplier 336 is of the type used in digital signal processing, arithmetic units in CPUs, and graphics processing units (GPUs).

Adder 338 is in communication with multiplier 336. In at least some embodiments, adder 338 is configured to add the product value from multiplier 336 to input sum value 326A to produce output sum value 326B. In at least some embodiments, adder 338 is configured to receive the product value from multiplier 336 and input sum value 326A from an adder of an upstream MAC unit. In at least some embodiments, adder 338 is configured to transmit output sum value 326B to an adder of a downstream MAC unit or an on-chip memory, such as memory 216 of FIG. 2. In at least some embodiments, adder 338 is configured to generally perform addition of two data values. In at least some embodiments, adder 338 is implemented as a digital adder circuit, such as those commonly found in FPGA or ASIC designs. In at least some embodiments, adder 338 is of the type used in arithmetic logic units (ALUs) within CPUs, digital signal processing, and control systems. In at least some embodiments, such as in the most upstream MAC unit of a column, an adder is not included in the MAC unit, because there is no upstream MAC unit from which to receive an input sum value, and the product value produced by the multiplier is transmitted to an adder of a downstream MAC unit as the output sum value.

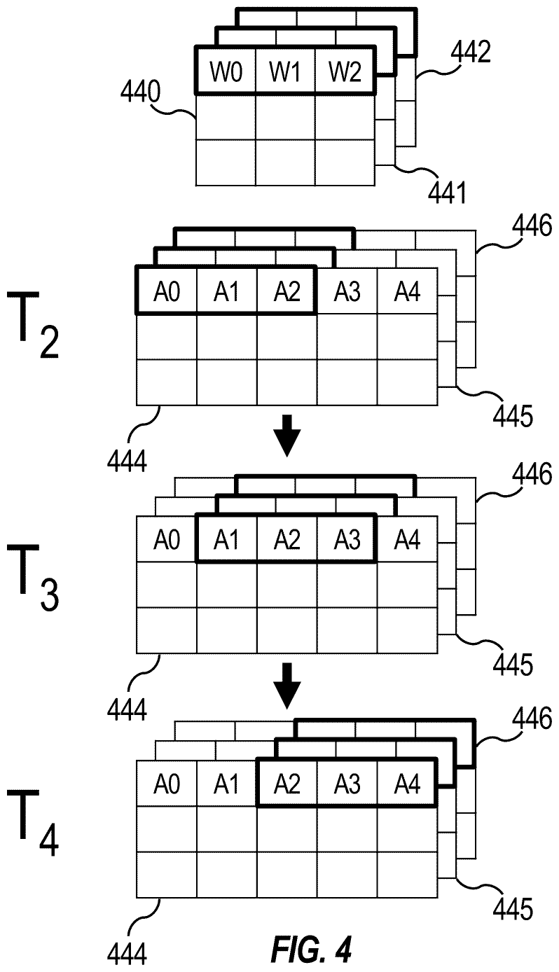

FIG. 4 is a schematic diagram of a depthwise convolution process, according to at least some embodiments of the subject disclosure. The diagram includes channel kernels 440, 441, and 442, and channel activation matrices 444, 445, and 446 through time periods T₂, T₃, and T₄.

To perform depthwise convolution with input and output parallelism, the most upstream MAC units, such as MAC unit 220A of FIG. 2, receive activation values A₀, one for each channel, of a systolic array in an initial time period T₀. In a subsequent time period T₁, activation values A₀ are transmitted from the most upstream MAC units to the immediately downstream MAC units, such as MAC unit 220B of FIG. 2, and the most upstream MAC units receive activation values A₁. During time periods T₀ and T₁, no computations are performed.

In a subsequent time period T₂, activation values A₁ are transmitted from the most upstream MAC units to the immediately downstream MAC units, activation values A₀ are transmitted from the immediately downstream MAC units to the next immediately downstream MAC units, and the most upstream MAC units receive activation values A₂. During time period T₂, MAC units have activation values and weight values suitable for performing computations.

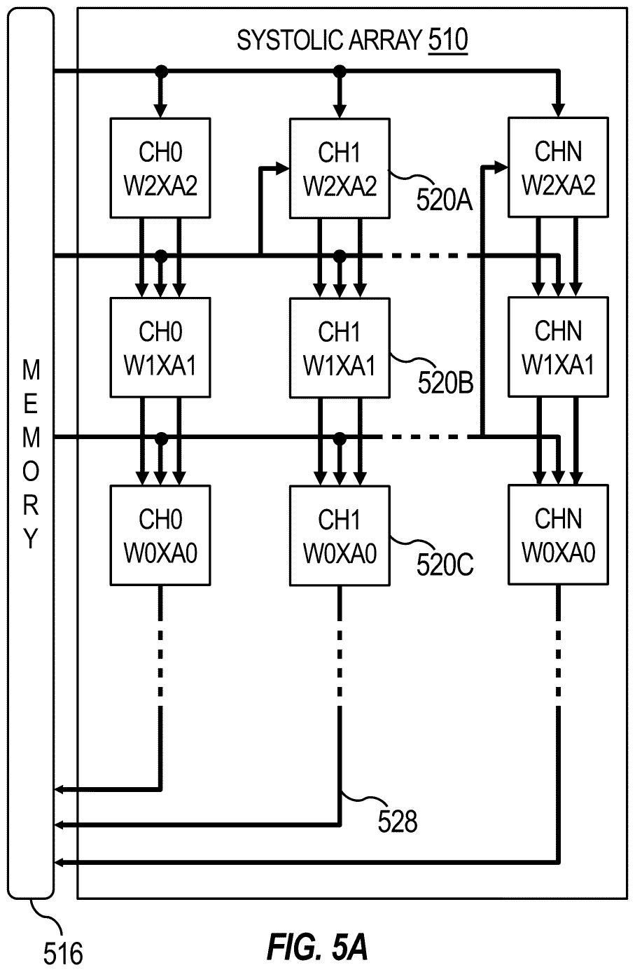

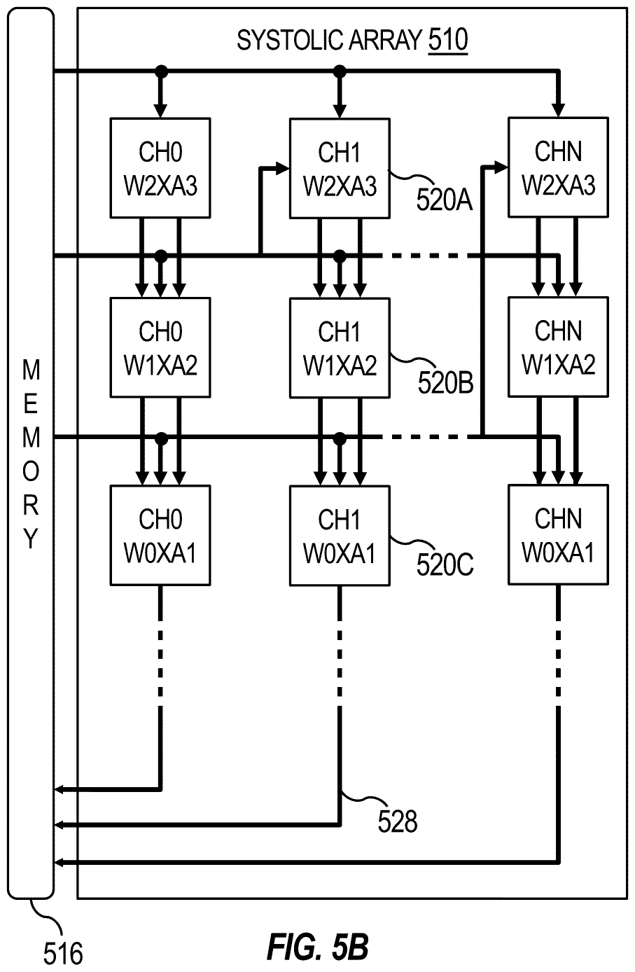

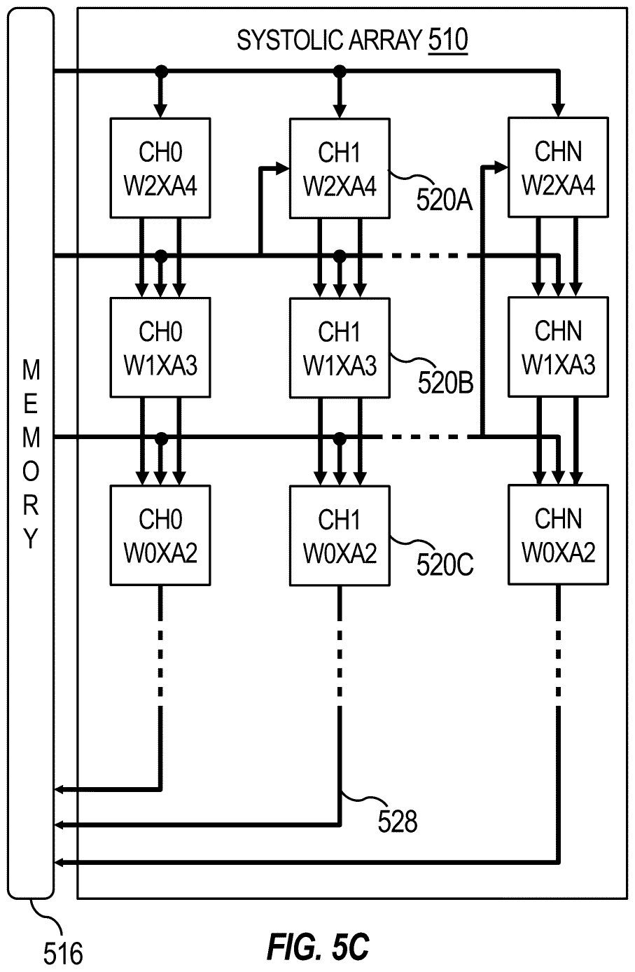

FIG. 5A is a schematic diagram of a systolic array 510 at time period T₂, according to at least some embodiments of the subject disclosure. Each column of MAC units in systolic array 510 is storing a weight value and an activation value for a channel. For example, most upstream MAC unit 520A is storing weight value W2 and activation value A2 for channel CH1, immediately downstream MAC unit 520B is storing weight value W1 and activation value A1 for channel CH1, and next immediately downstream MAC unit 520C is storing weight value W0 and activation value A0 for channel CH1. In other words, systolic array 510 is in a state for performing a computation of depthwise convolution with input and output parallelism.

In a subsequent time period T₃, activation values A₂ are transmitted from the most upstream MAC units to the immediately downstream MAC units, activation values A₁ are transmitted from the immediately downstream MAC units to the next immediately downstream MAC units, and the most upstream MAC units receive activation values A₃. During time period T₃, MAC units have activation values and weight values suitable for performing computations of depthwise convolution with input and output parallelism.

FIG. 5B is a schematic diagram of a systolic array 510 at time period T₃, according to at least some embodiments of the subject disclosure. Each column of MAC units in systolic array 510 is storing a weight value and an activation value for a channel. For example, most upstream MAC unit 520A is storing weight value W2 and activation value A3 for channel CH1, immediately downstream MAC unit 520B is storing weight value W1 and activation value A2 for channel CH1, and next immediately downstream MAC unit 520C is storing weight value W0 and activation value A1 for channel CH1.

In a subsequent time period T₄, activation values A₃ are transmitted from the most upstream MAC units to the immediately downstream MAC units, activation values A₂ are transmitted from the immediately downstream MAC units to the next immediately downstream MAC units, and the most upstream MAC units receive activation values A₄. During time period T₄, MAC units have activation values and weight values suitable for performing computations of depthwise convolution with input and output parallelism.

FIG. 5C is a schematic diagram of a systolic array 510 at time period T₄, according to at least some embodiments of the subject disclosure. Each column of MAC units in systolic array 510 is storing a weight value and an activation value for a channel. For example, most upstream MAC unit 520A is storing weight value W2 and activation value A4 for channel CH1, immediately downstream MAC unit 520B is storing weight value W1 and activation value A3 for channel CH1, and next immediately downstream MAC unit 520C is storing weight value W0 and activation value A2 for channel CH1.

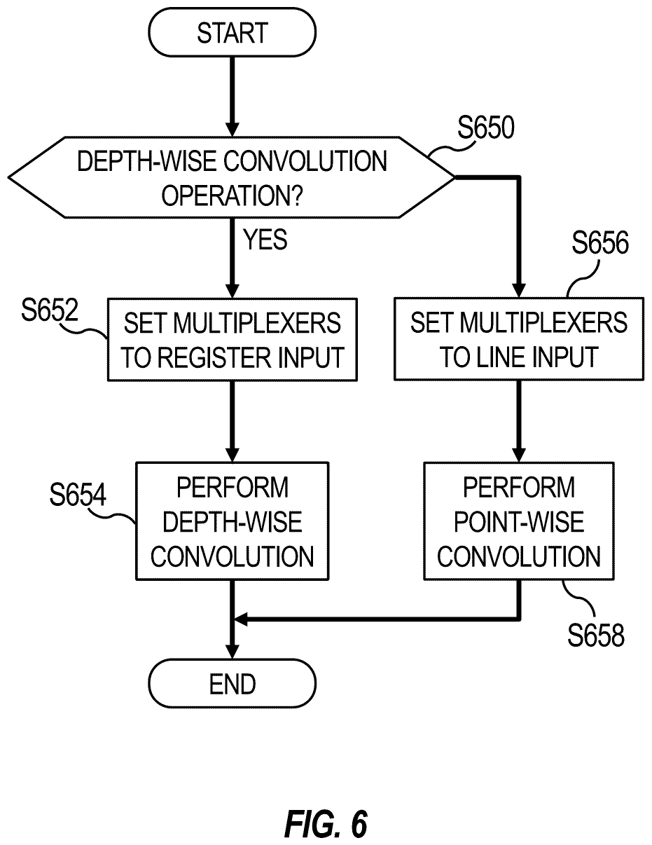

FIG. 6 is an operational flow for performing convolution using a systolic array, according to at least some embodiments of the subject disclosure. In at least some embodiments, the operational flow provides a method of an operational flow for performing convolution using a systolic array, according to at least some embodiments of the subject disclosure. In at least some embodiments, the method is performed by a controller of an integrated circuit, such as controller 118 of FIG. 1.

At S650, the controller determines whether the operation is depthwise convolution. In response to the controller determining that the convolution operation is not depthwise convolution, the operational flow proceeds to set multiplexers to line input at S656. In response to the controller determining that the operation is depthwise convolution, the operational flow proceeds to set multiplexers to register input at S652. In at least some embodiments, the operation is specified by a host machine, such as host computer 102 of FIG. 1.

At S652, the controller sets the multiplexers to register input. In at least some embodiments, the controller sets the multiplexers to register input by configuring the multiplexers to form connections from the activation registers to the multipliers. In at least some embodiments, the controller sets the multiplexers to route activation values from the registers.

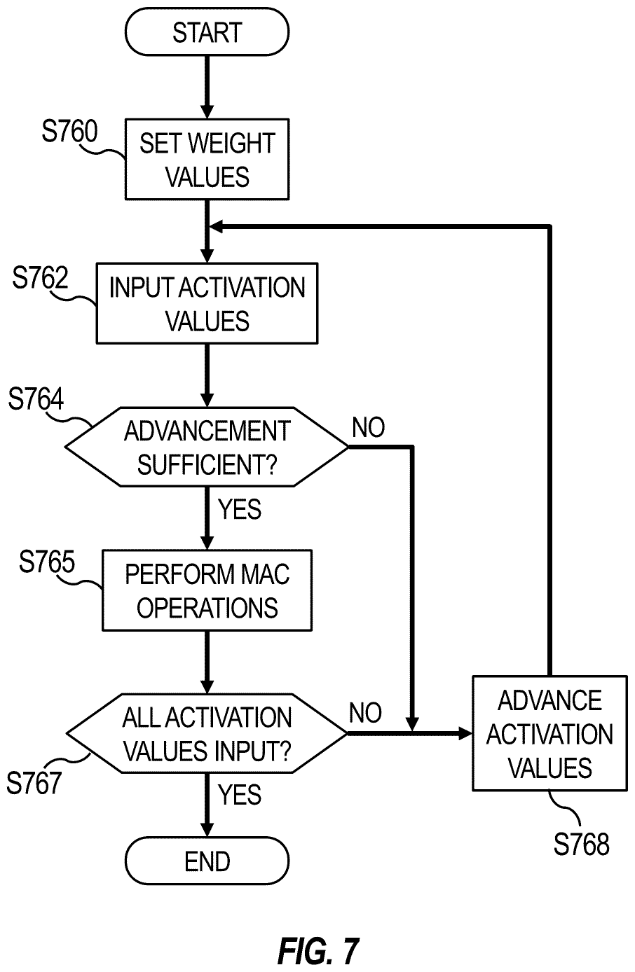

At S654, the controller performs depthwise convolution. In at least some embodiments, the controller performs depthwise convolution with input and output parallelism. In at least some embodiments, the controller performs depthwise convolution with input and output parallelism by using the configured systolic array. In at least some embodiments, the controller performs depthwise convolution in accordance with the operational flow of FIG. 7, described hereinafter. In at least some embodiments, the controller is configured to perform depth-wise convolution by advancing the activation value to the activation register of each MAC unit from the activation register of an immediate upstream MAC unit, and selecting, for transmission by each multiplexer, the activation register.

At S656, the controller sets the multiplexers to line input. In at least some embodiments, the controller sets the multiplexers to line input by configuring the multiplexers to form connections from the input lines to the multipliers. In at least some embodiments, the controller sets the multiplexers to route activation values from the input lines.

At S658, the controller performs pointwise convolution. In at least some embodiments, the controller performs pointwise convolution by using the configured systolic array. In at least some embodiments, the controller is configured to perform point-wise convolution by transmitting the activation value of each MAC unit among the plurality of MAC units through the input line of the MAC unit, and selecting, for transmission by each multiplexer, the input line.

FIG. 7 is an operational flow for depth-wise convolution with input and output parallelism, according to at least some embodiments of the subject disclosure. In at least some embodiments, the operational flow provides a method of an operational flow for depth-wise convolution with input and output parallelism, according to at least some embodiments of the subject disclosure. In at least some embodiments, the method is performed by a controller of an integrated circuit, such as controller 118 of FIG. 1.

At S760, the controller or a section thereof sets weight values. In at least some embodiments, the controller transmits weight values to weight registers. In at least some embodiments, the controller causes a memory to transmit weight values to the weight registers of MAC units in a systolic array. In at least some embodiments, the controller initializes the MAC units with the weights for the depthwise convolution operation.

At S762, the controller or a section thereof inputs activation values. In at least some embodiments, the controller transmits activation values to upstream MAC units. In at least some embodiments, the controller causes the memory to transmit activation values to activation registers of the upstream MAC units in the systolic array. In at least some embodiments, the controller transmits each activation value through a different input line of the systolic array. In at least some embodiments, the controller is configured to transmit, to the activation register of the upstream MAC unit, the activation value through the input line of the upstream MAC unit. In at least some embodiments, the controller is configured to transmit, to at least some upstream MAC units, activation values through an activation input line connector that connects an input line to a most upstream MAC unit of a column, such as activation input line connector 223 of FIG. 2. In at least some embodiments, the controller is configured to transmit, to the activation register of the upstream MAC unit of at least one column, the activation value through the input line of a downstream MAC unit of the at least one column.

At S764, the controller or a section thereof determines whether activation values are sufficiently advanced. In response to determining that activation values are not sufficiently advanced, the operational flow proceeds to advance activation values at S768. In response to determining that activation values are sufficiently advanced, the operational flow proceeds to MAC operation performance at S765. In at least some embodiments, the controller determines whether the activation values have sufficiently advanced through the activation registers so that each MAC unit with a weight value also has an activation value. In at least some embodiments, the controller determines whether the systolic array is ready to perform MAC operations. In at least some embodiments, the controller determines whether the systolic array is ready to begin performing depthwise convolution with input and output parallelism.

At S765, the controller or a section thereof performs MAC operations. In at least some embodiments, the controller causes the MAC units to perform multiplication of the weight values and activation values to produce product values. In at least some embodiments, the controller causes the MAC units to perform accumulation of the product values and input sum values to produce output sum values. In at least some embodiments, the controller causes downstream MAC units to transmit the output sum values to a memory. In at least some embodiments, the controller causes the memory to store the output sum values.

At S767, the controller or a section thereof determines whether all activation values have been input. In response to determining that all activation values have not been input, the operational flow proceeds to activation value advancement at S768. In response to determining that all activation values have been input, the operational flow ends. In at least some embodiments, the controller determines whether all activation values of channel activation matrices have been input. In at least some embodiments, the controller determines whether the depthwise convolution process is complete or whether more activation values need to be processed. In at least some embodiments, the controller tracks input of activation values as specified by a host machine, such as host computer 102 of FIG. 1.

At S768, the controller or a section thereof advances activation values. In at least some embodiments, the controller advances the activation values from upstream activation registers to the next downstream registers. In at least some embodiments, the controller prepares the systolic array for the next set of MAC operations. In at least some embodiments, the controller causes the activation values to move through the systolic array, enabling parallel processing of multiple channels.

In at least some embodiments, depthwise convolution is performed for a kernel having more than one row of weight values. In at least some embodiments, the operational flow of FIG. 7 will be performed once for each row of weight values in the kernel. In at least some embodiments, depthwise convolution is performed for a kernel having rows of more weight values than MAC units per column of the systolic array. In at least some embodiments, such as those in which not all MAC units of the systolic array include activation registers, depthwise convolution is performed for a kernel having rows of more weight values than registers per column of the systolic array. In at least some embodiments, the operational flow of FIG. 7 will be performed additional times until all of the weight values in a row of the kernel have been processed.

While embodiments of the present invention have been described, the technical scope of any subject matter claimed is not limited to the above described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, depth-wise convolution with input and output parallelism is performed by a plurality of multiply-and-accumulate (MAC) units, each MAC unit including a weight register configured to store a weight value, an activation register configured to store an activation value, a multiplexer configured to transmit the activation value received from one of the activation register and an input line, a multiplier configured to multiply the weight value from the weight register and the activation value transmitted from the multiplexer to produce a product value, and an adder configured to add the product value from the multiplier and an input sum value to produce an output sum value, a memory in communication with the plurality of MAC units, and a controller configured to transmit, from the memory, the weight value of each MAC unit among the plurality of MAC units to the weight register of the MAC unit, and transmit, from the memory, the activation value to an upstream MAC unit among the plurality of MAC units, and store, on the memory, the output sum value produced by a last MAC unit among the plurality of MAC units. In at least some embodiments, the controller is further configured to perform one of point-wise convolution and depth-wise convolution. In at least some embodiments, the controller is configured to perform point-wise convolution by transmitting the activation value of each MAC unit among the plurality of MAC units through the input line of the MAC unit, and selecting, for transmission by each multiplexer, the input line. In at least some embodiments, the controller is configured to perform depth-wise convolution by advancing the activation value to the activation register of each MAC unit from the activation register of an immediate upstream MAC unit, and selecting, for transmission by each multiplexer, the activation register. In at least some embodiments, the plurality of MAC units are arranged in a column of a systolic array. In at least some embodiments, the systolic array includes a plurality of columns forming a matrix of MAC units. In at least some embodiments, the input line of each MAC unit among the plurality of MAC units is shared among corresponding MAC units of each column. In at least some embodiments, the activation register of the upstream MAC unit of at least one column is configured to receive the activation value through the input line of a downstream MAC unit of the at least one column. In at least some embodiments, the activation register of the upstream MAC unit is configured to receive the activation value through the input line of the upstream MAC unit.

In at least some embodiments, depth-wise convolution with input and output parallelism is performed by a plurality of multiply-and-accumulate (MAC) units, each MAC unit is configured to store a weight value and an activation value, transmit the activation value received from one of an activation register storing the activation value and an input line, multiply the weight value and the transmitted activation value to produce a product value, and add the product value and an input sum value to produce an output sum value, a memory in communication with the plurality of MAC units, and a controller configured to transmit, from the memory, the weight value of each MAC unit among the plurality of MAC units to the MAC unit, and transmit, from the memory, the activation value to an upstream MAC unit among the plurality of MAC units, and store, on the memory, the output sum value produced by a last MAC unit among the plurality of MAC units. In at least some embodiments, the controller is further configured to perform one of point-wise convolution and depth-wise convolution. In at least some embodiments, the controller is configured to perform point-wise convolution by transmitting the activation value of each MAC unit among the plurality of MAC units through the input line of the MAC unit, and selecting, for transmission by each multiplexer, the input line. In at least some embodiments, the controller is configured to perform depth-wise convolution by advancing the activation value to each MAC unit from an immediate upstream MAC unit, and selecting, for transmission by each multiplexer, the activation register. In at least some embodiments, the plurality of MAC units are arranged in a column of a systolic array. In at least some embodiments, the systolic array includes a plurality of columns forming a matrix of MAC units. In at least some embodiments, the input line of each MAC unit among the plurality of MAC units is shared among corresponding MAC units of each column. In at least some embodiments, the controller is configured to transmit, to the activation register of the upstream MAC unit of at least one column, the activation value through the input line of a downstream MAC unit of the at least one column. In at least some embodiments, the controller is configured to transmit, to the activation register of the upstream MAC unit, the activation value through the input line of the upstream MAC unit.

In at least some embodiments, depth-wise convolution with input and output parallelism is performed by transmitting, from a memory of an integrated circuit, a weight value of each MAC unit among a plurality of MAC units of the integrated circuit, to a weight register of the MAC unit, transmitting, from the memory, an activation value to an activation register of each upstream MAC unit among the plurality of MAC units, transmitting, by a multiplexer of each MAC unit among the plurality of MAC units connected to the activation register of the MAC unit, the activation value from one of the activation register and an input line to a multiplier of the MAC unit, multiplying, by a multiplier of each MAC unit among the plurality of MAC units connected to the multiplexer and the weight register of the MAC unit, the weight value from the weight register and the activation value transmitted from the multiplexer to produce a product value, adding, by an adder of each downstream MAC unit among the plurality of MAC units connected to the multiplier of the MAC unit, the product value from the multiplier and an input sum value to produce an output sum value, and storing, on the memory, the output sum value produced by a last MAC unit among the plurality of MAC units. In at least some embodiments, the method further includes advancing the activation value to each MAC unit from an immediate upstream MAC unit, and selecting, for transmission by each multiplexer, the activation register.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. An integrated circuit comprising:
a plurality of multiply-and-accumulate (MAC) units, each MAC unit including
a weight register configured to store a weight value,
an activation register configured to store an activation value,
a multiplexer configured to transmit the activation value received from one of the activation register and an input line,
a multiplier configured to multiply the weight value from the weight register and the activation value transmitted from the multiplexer to produce a product value, and
an adder configured to add the product value from the multiplier and an input sum value to produce an output sum value;
a memory in communication with the plurality of MAC units; and
a controller configured to
transmit, from the memory, the weight value of each MAC unit among the plurality of MAC units to the weight register of the MAC unit, and
transmit, from the memory, the activation value to an upstream MAC unit among the plurality of MAC units, and
store, on the memory, the output sum value produced by a last MAC unit among the plurality of MAC units.

2. The integrated circuit of claim 1, wherein the controller is further configured to perform one of point-wise convolution and depth-wise convolution.

3. The integrated circuit of claim 2, wherein the controller is configured to perform point-wise convolution by
transmitting the activation value of each MAC unit among the plurality of MAC units through the input line of the MAC unit, and
selecting, for transmission by each multiplexer, the input line.

4. The integrated circuit of claim 2, wherein the controller is configured to perform depth-wise convolution by
advancing the activation value to the activation register of each MAC unit from the activation register of an immediate upstream MAC unit, and
selecting, for transmission by each multiplexer, the activation register.

5. The integrated circuit of claim 1, wherein the plurality of MAC units are arranged in a column of a systolic array.

6. The integrated circuit of claim 5, wherein the systolic array includes a plurality of columns forming a matrix of MAC units.

7. The integrated circuit of claim 6, wherein the input line of each MAC unit among the plurality of MAC units is shared among corresponding MAC units of each column.

8. The integrated circuit of claim 7, wherein the activation register of the upstream MAC unit of at least one column is configured to receive the activation value through the input line of a downstream MAC unit of the at least one column.

9. The integrated circuit of claim 1, wherein the activation register of the upstream MAC unit is configured to receive the activation value through the input line of the upstream MAC unit.

10. An integrated circuit comprising:
a plurality of multiply-and-accumulate (MAC) units, each MAC unit is configured to
store a weight value and an activation value,
transmit the activation value received from one of an activation register storing the activation value and an input line,
multiply the weight value and the transmitted activation value to produce a product value, and
add the product value and an input sum value to produce an output sum value;
a memory in communication with the plurality of MAC units; and
a controller configured to
transmit, from the memory, the weight value of each MAC unit among the plurality of MAC units to the MAC unit, and
transmit, from the memory, the activation value to an upstream MAC unit among the plurality of MAC units, and
store, on the memory, the output sum value produced by a last MAC unit among the plurality of MAC units.

11. The integrated circuit of claim 10, wherein the controller is further configured to perform one of point-wise convolution and depth-wise convolution.

12. The integrated circuit of claim 11, wherein the controller is configured to perform point-wise convolution by
transmitting the activation value of each MAC unit among the plurality of MAC units through the input line of the MAC unit, and
selecting, for transmission by each multiplexer, the input line.

13. The integrated circuit of claim 11, wherein the controller is configured to perform depth-wise convolution by
advancing the activation value to each MAC unit from an immediate upstream MAC unit, and
selecting, for transmission by each multiplexer, the activation register.

14. The integrated circuit of claim 10, wherein the plurality of MAC units are arranged in a column of a systolic array.

15. The integrated circuit of claim 14, wherein the systolic array includes a plurality of columns forming a matrix of MAC units.

16. The integrated circuit of claim 15, wherein the input line of each MAC unit among the plurality of MAC units is shared among corresponding MAC units of each column.

17. The integrated circuit of claim 16, wherein the controller is configured to transmit, to the activation register of the upstream MAC unit of at least one column, the activation value through the input line of a downstream MAC unit of the at least one column.

18. The integrated circuit of claim 10, wherein the controller is configured to transmit, to the activation register of the upstream MAC unit, the activation value through the input line of the upstream MAC unit.

19. A method comprising:
transmitting, from a memory of an integrated circuit, a weight value of each MAC unit among a plurality of MAC units of the integrated circuit, to a weight register of the MAC unit,
transmitting, from the memory, an activation value to an activation register of each upstream MAC unit among the plurality of MAC units,
transmitting, by a multiplexer of each MAC unit among the plurality of MAC units connected to the activation register of the MAC unit, the activation value from one of the activation register and an input line to a multiplier of the MAC unit,
multiplying, by a multiplier of each MAC unit among the plurality of MAC units connected to the multiplexer and the weight register of the MAC unit, the weight value from the weight register and the activation value transmitted from the multiplexer to produce a product value,
adding, by an adder of each downstream MAC unit among the plurality of MAC units connected to the multiplier of the MAC unit, the product value from the multiplier and an input sum value to produce an output sum value, and
storing, on the memory, the output sum value produced by a last MAC unit among the plurality of MAC units.

20. The method of claim 19, further comprising advancing the activation value to each MAC unit from an immediate upstream MAC unit, and selecting, for transmission by each multiplexer, the activation register.
